(19) United States
(12) Patent Application Publication
(10) Pub. No.: US 2010/0205435 A1
(43) Pub. Date: Aug. 12, 2010

(54) METHOD FOR IMPLEMENTING LOCATION BASED SERVICES, METHOD FOR BROADCASTING GEOGRAPHIC LOCATION INFORMATION OF BASE STATION, AND DEVICE THEREOF

(76) Inventor: Yong Xie, Shenzhen (CN)

Correspondence Address: Huawei/BHGL, P.O. Box 10395, Chicago, IL, 60610, US

(21) Appl. No.: 12/762,862

(22) Filed: Apr. 19, 2010

Related U.S. Application Data
(63) Continuation of application No. PCT/CN2008/072749, filed on Oct. 17, 2008.

(30) Foreign Application Priority Data
Oct. 19, 2007 (CN) 200710165018.7

(51) Int. Cl. H04W 12/06; H04L 9/08

(52) U.S. Cl. 713/168; 726/3; 380/270; 380/278

(57) ABSTRACT

A method and device for broadcasting geographic location information of a base station (BS) and relates to radio communication technologies is disclosed. The purpose is to improve the security of the world interoperability for microwave access (WiMAX) network in the provisioning of location based services (LBS) in the prior art. A method for implementing LBSs includes: In a WiMAX system providing LBSs, the system obtains an encryption key for encrypting the geographic location information of the BS; and encrypts the broadcasted geographic location information of the BS based on the obtained key. The technical solution of the disclosure may be applied in the WiMAX system.

### CROSS-REFERENCE TO RELATED APPLICATIONS

This application is a continuation of International Application No. PCT/CN2008/072749, filed on Oct. 17, 2008, which claims priority to Chinese Patent Application No. 200710165018.7, filed on Oct. 19, 2007, both of which are hereby incorporated by reference in their entirety.

### FIELD OF THE INVENTION

The disclosure relates to radio communication technologies, and in particular, to a method for implementing location based services (LBSs), a method for broadcasting geographic location information of a base station, and a device thereof.

### BACKGROUND OF THE INVENTION

World Interoperability for Microwave Access (WiMAX) is a radio metropolitan area network (MAN) communication technology based on the IEEE802.16 standard. The WiMAX can provide Internet-oriented high-speed connections.

FIG. 1 shows a structure of a WiMAX network system. The WiMAX network system includes:

a mobile station (MS), through which a subscriber accesses the WiMAX network;

an access service network (ASN), being a network function set that provides a WiMAX MS with radio access services, and including a base station (BS) and an access service network gateway (ASN-GW), where the BS is configured to provide functions such as layer 2 (L2) connection between the BS and the MS and radio resource management; and the ASN-GW is configured to provide the MS with authentication, authorization, and accounting (AAA) client functions, and provide the MS with the layer 3 (L3) information relay function and intra-ASN handover function; and

a connect service network (CSN), configured to: provide the WiMAX MS with IP connection services, perform functions such as MS IP address allocation, Internet access, AAA proxy or server, and subscriber-based authorization control, and support multiple WiMAX services, such as LBS, end-to-end service, and multimedia broadcast and multicast service.

The LBS provides the subscriber with the current location information of an MS in the WiMAX system.

FIG. 2 shows a structure for implementing LBSs in the WiMAX system. The structure includes:

a location server (LS), residing in the CSN, responsible for providing an external or internal requesting entity with the current location information of a located MS, and capable of triggering a location controller (LC) in the ASN to locate the located MS and providing the location calculation function;

the LC, residing in the ASN (generally in the ASN-GW), and responsible for measuring the location of the located MS and implementing location related processes, calculating the location information of the located MS according to the location calculation function provided by the LS, and returning the obtained location information to the LS; and

a location agent (LA), residing in the BS and the MS and responsible for measuring and collecting related parameters for locating and calculating the location information of the located MS, and providing the LC with the related parameters for location information calculation.

The prior art has at least the following problems: Currently, when the LBS is implemented in the WiMAX system, the LS may send the current location information of the located MS to an external or internal device so long as the LS receives a location request from the external or internal device. In this case, it is important to legally use the MS location information. Based on the solution of the prior art that provides the MS location information freely, certain unauthorized devices may also request the MS location information, which may bring about threats to the security of current location information of the MS.

In addition, the navigation-based LBS may be implemented in the WiMAX system. The details are as follows: The BS on the network periodically broadcasts the geographic location information (including latitude and longitude information and height information) of the BS and neighboring BSs; after receiving the location information, the MS calculates the current geographic location range of the MS according to a certain algorithm; and the MS provides the application layer with the obtained geographic location range for use. In general, the MS may successively obtain the current location information of the MS by using this solution, and thus provide navigation services according to the information on a map.

Similarly, if the BS in the WiMAX system freely broadcasts the geographic location information of the BS and neighboring BSs to all MSs, all the MSs may freely obtain their geographic location information. This brings about security threats to the system and affects the profits of the carriers.

### SUMMARY OF THE INVENTION

Embodiments of the disclosure provide a method for implementing LBSs, so that the current location information of an MS can be securely provided in a WiMAX system.

Embodiments of the disclosure also provide a method for broadcasting BS location information, so that the BS location information can be securely provided to an MS in a WiMAX system.

A method for implementing LBSs in an embodiment of the disclosure includes: authenticating a requesting party that requests location information of an MS in a WiMAX system providing LBSs; and providing the requesting party with the requested location information of the MS after the authentication succeeds.

A device in a WiMAX system providing LBSs in an embodiment of the disclosure includes:

an authenticating unit, configured to authenticate a requesting party that requests location information of an MS in the WiMAX system; and

a location information providing unit, configured to provide the requesting party with the requested location information of the MS after the authentication succeeds.

A method for broadcasting geographic location information of a BS in an embodiment of the disclosure includes: by a WiMAX system providing LBSs, obtaining a key for encrypting the geographic location information of the BS; encrypting the broadcasted BS location information based on the obtained key; and broadcasting the encrypted geographic location information of the BS.

A BS in a WiMAX system providing LBSs in an embodiment of the disclosure includes:

a key obtaining unit, configured to obtain a key;

an encrypting unit, configured to encrypt geographic location information of the BS by using the obtained key; and

a geographic location information broadcasting unit, configured to broadcast encrypted geographic location information of a BS.

In embodiments of the disclosure, the requesting party that requests the location information of an MS in the WiMAX system is authenticated; and the location information of the MS is provided to the requesting party only after the authentication succeeds. In this way, the location information of the MS can be properly protected.

In addition, in embodiments of the disclosure, the broadcasted geographic location information is encrypted by the BS in the WiMAX system, so that only an MS that obtains the key can decrypt the geographic location information of the BS. Thus, the security of the navigation-based LBS is improved, and this guarantees the carriers' profits from the services provided by the carriers.

### BRIEF DESCRIPTION OF THE DRAWINGS

FIG. 1 shows a structure of a WiMAX network system;

FIG. 2 shows a structure for implementing LBSs in a WiMAX system in the prior art;

FIG. 3 is a flowchart of a method for implementing LBSs in an embodiment of the disclosure;

FIG. 4 illustrates a process of an embodiment of a method for implementing LB Ss;

FIG. 5 is a flowchart of a method for broadcasting geographic location information of a BS in an embodiment of the disclosure;

FIG. 6 illustrates a process of an embodiment of a method for broadcasting geographic location information of a BS;

FIG. 7 is a first schematic diagram illustrating a structure of a device in a WiMAX system providing LBSs in an embodiment of the disclosure;

FIG. 8 is a second schematic diagram illustrating a structure of a device in a WiMAX system providing LBSs in an embodiment of the disclosure;

FIG. 9 shows a structure of a BS in a WiMAX system providing LBSs in an embodiment of the disclosure; and

FIG. 10 shows a structure of an MS in a WiMAX system providing LBSs in an embodiment of the disclosure.

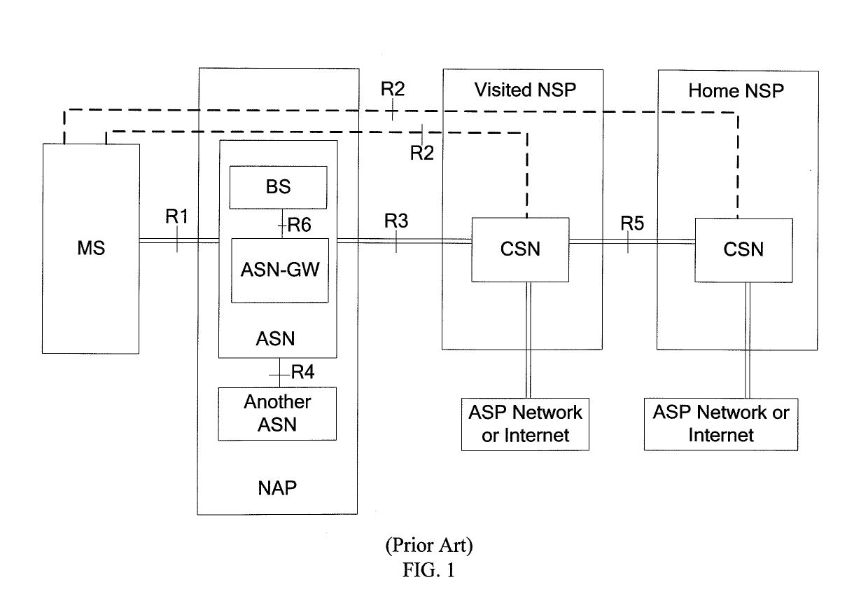

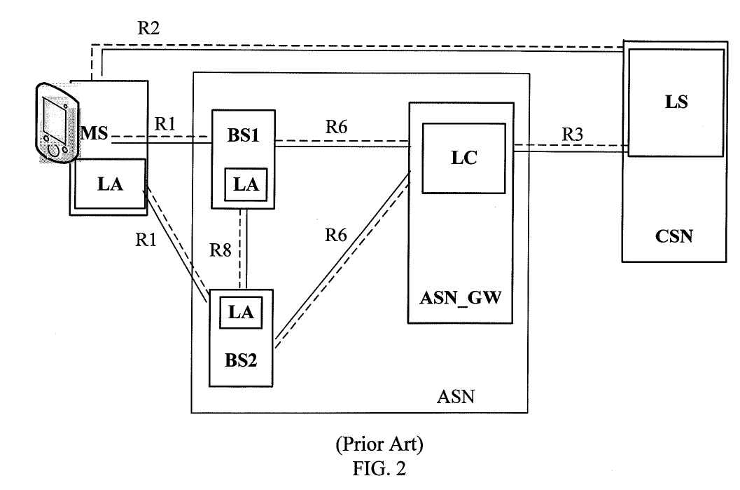

### DETAILED DESCRIPTION OF THE EMBODIMENTS

Embodiments of the disclosure provide a technical solution about how to securely provide LBS and geographic location information of the BS in the WiMAX system. The following describes a solution for providing LBSs securely.

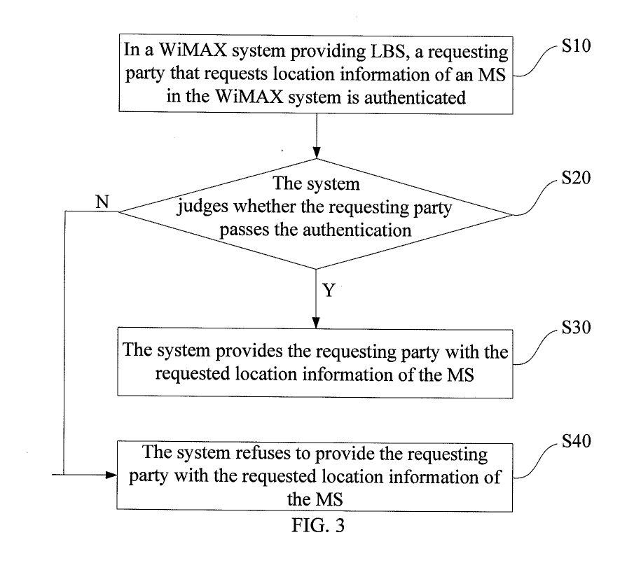

FIG. 3 is a flowchart of a method for implementing LBSs in an embodiment of the disclosure.

Step 10: In a WiMAX system providing LBSs, a requesting party that requests the location information of an MS in the WiMAX system is authenticated. The requesting party may be an external entity of the WiMAX system, such as an external website, or be an MS in the WiMAX system. The MS may locate itself or request location information of other MSs.

Step 20: The system judges whether the requesting party passes the authentication. If so, the process proceeds to step 30; otherwise, the process goes to step 40.

Step 30: The system provides the requesting party with the requested location information of the MS.

Step 40: The system refuses to provide the requesting party with the requested location information of the MS.

If the system determines that the authentication succeeds in step 20, the system may judge whether the requesting party is authorized to query the requested location information of the MS before step 30. If the requesting party is authorized to query the requested location information of the MS, the process proceeds to step 30. In step 30, to improve the security of the location information provided to the requesting party, the system may encrypt the location information of the MS. The process includes a step of deriving an encryption key for encrypting the location information from a root key LBS-RK and encrypting the location information.

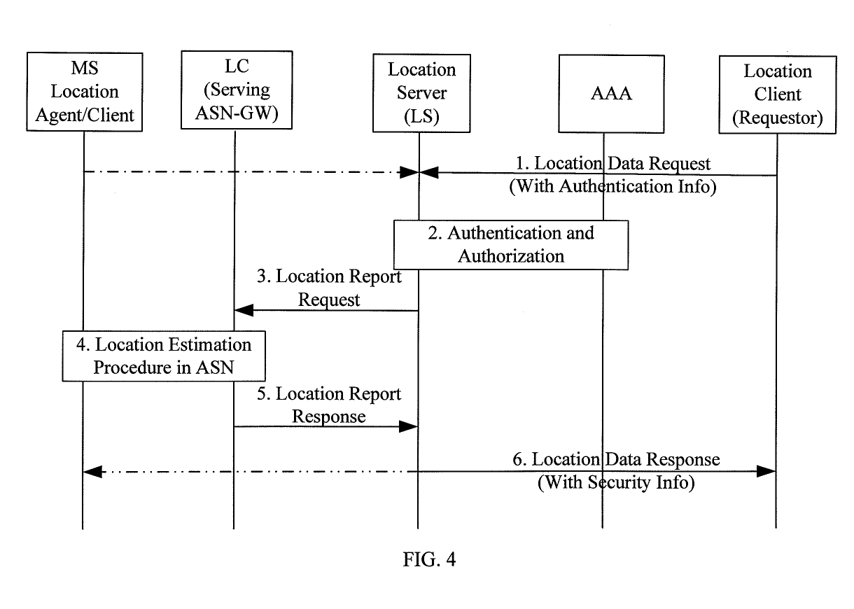

FIG. 4 illustrates a process of an embodiment of the method for implementing LBSs. As shown in FIG. 4, when a location client requests a location server (LS) for the location information of an MS, the location client sends a location information request to the LS, requesting the location information of the MS. The following describes a process of triggering an LBS traffic flow based on this embodiment.

Step 1: The location client sends a Location Data Request to the LS, requesting obtaining the location information of a specified MS. The location client adds required authentication information to the Location Data Request, so that the LS can authenticate and authorize the location client according to the carried authentication information.

Step 2: The LS authenticates and authorizes the location client according to the authentication information carried in the Location Data Request sent from the location client.

There are two types of location client. One type is a location client outside the system, that is, an entity outside the WiMAX system, for example, an external website. When the location client requesting the authentication information is an entity outside the WiMAX system, a shared key (marked as the LBS-RK) may be pre-negotiated between the WiMAX system and the location client. The LBS-RK in the WiMAX system may be configured on the LS or on the AAA server. When the location client sends a Location Data Request, the location client calculates a first authentication extension by using the LBS-RK according to an algorithm pre-negotiated between the location client and the system, and adds the calculated first authentication extension to the Location Data Request sent to the LS. After receiving the Location Data Request, the LS authenticates the first authentication extension by using the pre-negotiated LBS-RK according to the algorithm pre-negotiated between the LS and the location client. If the LBS-RK is configured on the AAA server, the LS needs to request the AAA server for the LBS-RK. The authentication process includes: calculating an authentication extension corresponding to the first authentication extension, authenticating the location client by judging whether the calculated authentication extension is the same as the first authentication extension carried in the received Location Data Request; if the two extensions are the same, passing the authentication of the location client and determining that the location client is legal; if the two extensions are different, determining that the location client is illegal, and rejecting the request of the location client.

The other type of location client is an accessed MS in the WiMAX system. If the MS locates itself or other MSs, the location client may generate an extended master session key (EMSK) when accessing the WiMAX system, and send the generated EMSK to the LS in the system to store the EMSK. The location client calculates a root key (marked as the LBS-RK) for location information according to the generated EMSK, and stores the LBS-RK in the location client and the system. In addition, the location client calculates a second authentication extension by using the calculated LBS-RK according to an algorithm pre-negotiated between the location client and the system, adds the calculated second authentication extension to a Location Data Request, and sends the Location Data Request to the LS. After receiving the Location Data Request, the LS authenticates the second authentication extension by using the stored LBS-RK according to an algorithm pre-negotiated between the LS and the location client. The authentication process includes: calculating an authentication extension corresponding to the second authentication extension, authenticating the location client by judging whether the calculated authentication extension is the same as the second authentication extension carried in the received Location Data Request; if the two extensions are the same, passing the authentication of the location client and determining that the location client is legal; if the two extensions are different, determining that the location client is illegal, and rejecting the request of the location client.

The Location Data Request sent by the location client may further include the ID of an MS to be located or the ID of the LS.

Step 3 to step 5 are a process of locating an MS, which already become a standard technology and therefore are not further described.

Step 6: After locating the MS, the LS may obtain the specific location information of the located MS, and add the obtained location information to a Location Data Response returned to the location client. In this way, the security of the location information in the Location Data Response may be guaranteed by the following two aspects:

Firstly, a third authentication extension is generated by using the LBS-RK, and the third authentication extension is carried in the Location Data Response. In this way, the location client can authenticate the Location Data Response based on the third authentication extension only after receiving the third authentication extension; the location client may determine that the received location information comes from the requested legal system only after the authentication succeeds.

Secondly, a key for encrypting the location information is calculated by using the LBS-RK according to an encryption algorithm. The calculated key is used to encrypt the location information (including location and precision information) carried in the Location Data Response, so that only the original location client can obtain the location information in the Location Data Response.

In this embodiment, when the LBS is implemented in the WiMAX system, the requesting party that requests the location information of an MS in the WiMAX system is authenticated; and the location information of the MS is provided to the requesting party only after the authentication succeeds. In this way, the location information of the MS can be properly protected.

In addition, for the navigation-based LBS implemented in the WiMAX system, the geographic location information of the BS is a parameter with a certain security level, and cannot be obtained freely by an MS. Further, the system should charge the MS for the geographic location information. If the system broadcasts geographic location information of the BS freely as it does in the prior art, the MS may obtain the geographic location information of the BS free of charge. This brings about certain security threats to the system. Therefore, in this embodiment, the broadcasted geographic location information of the BS should be encrypted before being sent. The following describes a method for broadcasting the geographic location information of the BS in an embodiment of the disclosure.

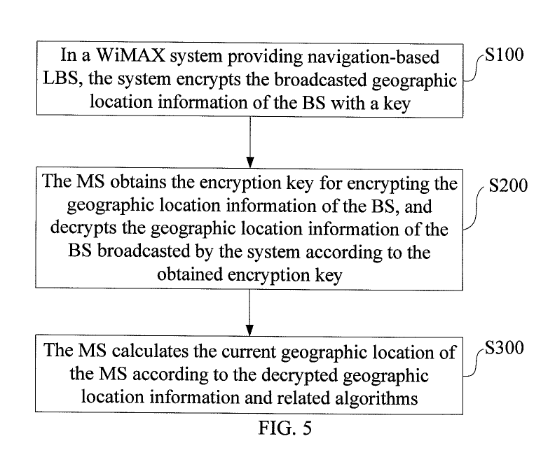

FIG. 5 is a flowchart of a method for broadcasting geographic location information of the BS in an embodiment of the disclosure.

Step 100: In the WiMAX system providing navigation-based LBSs, the system encrypts the broadcasted geographic location information of a BS with a key. A message structure of the broadcasted geographic location information of the BS is defined in the IEEE 802.16g protocol. That is, the TLV encoded information for carrying the geographic location information of the BS in this structure needs to be encrypted.

Because the BS broadcasts the geographic location information of the BS through the media access control (MAC) layer, the geographic location information of the BS should be encrypted in the BS. Thus, the BS should first obtain an encryption key for encrypting the location information.

Step 200: The MS obtains the encryption key for encrypting the geographic location information of the BS, and decrypts the geographic location information of the BS broadcasted by the system according to the obtained encryption key.

Step 300: The MS calculates the current geographic location of the MS according to the decrypted geographic location information and related algorithms.

In step 100, the methods for the BS to obtain the key for encrypting the geographic location information of the BS include but are not limited to the following:

Method 1: The operation, maintenance, and administration (OMA) device generates the encryption key, which is the same in a same network access point (NAP) or authenticator domain. The OMA device may send the generated key to the ASN GW/LC, and then the ASN GW/LC may send the key to the BS.

Method 2: The ASN GW generates the encryption key. After generating the key at random, each ASN GW sends the key to each BS under the control of the ASN GW.

Method 3: The LS or the AAA server generates the encryption key at random, and sends the key to all the LCs on the NAP network connected to the LS or the AAA server. Then, the LCs send the key to the BS.

Method 4: The system individually sets a functional entity for generating the encryption key, that is, the system sets a broadcast or multicast control entity. The entity generates and maintains the encryption key, and sends the key to each BS under the control of the entity. The entity may reside in an ASN GW on the network.

In the preceding methods for the BS to obtain the key, the OMA device, the ASN GW, the LC, or the AAA server may update the generated key according to the actual situation, and notify the BS of the updated key directly or indirectly through the preceding transmission method.

In step 200, the methods for the MS to obtain the key for encrypting the geographic location information of the BS in the system include but are not limited to the following:

Method 1: Encryption keys for encrypting the geographic location information of the BS are stored in the BS, and each key is assigned a corresponding group security association ID (GSAID). When the MS needs an encryption key, the MS sends a Key Request that carries a GSAID corresponding to the requested key to the BS. Then, the BS searches for an encryption key according to the GSAID carried in the Key Request, and sends the found encryption key to the MS.

Method 2: When the MS initiates a location request to the system or the system triggers a location request to the MS, the MS requests an encryption key for encrypting the geographic location information of the BS from the system through an application layer message. The system then sends the encryption key for encrypting the geographic location information of the BS to the MS according to the request of the MS. In this method, the encryption key for encrypting the geographic location information of the BS needs to be configured at the application layer, for example, on the LS.

Accordingly, if the system updates an encryption key for encrypting the geographic location information of the BS, the MS should obtain the updated encryption key concurrently. Only in this way can the MS decrypt the broadcasted geographic location information of the BS by using the encryption key. The methods for the MS to obtain the updated encryption key include but are not limited to the following:

Method 1: The system notifies the MS of the updated encryption key. For example, for an MS in active mode, the BS may actively send the updated key to the MS through a Key Request/Reply after obtaining an updated key. In another example, for an MS in idle mode, after the system updates an encryption key, the system may check which MSs in the paging controller (PC)/location register (LR) request the navigation (or key) service, page the requesting MSs, and add the updated key information to the paging message. In this way, the MSs can obtain the updated key without entering the active mode again.

Method 2: After updating the key, the system notifies the MS of the update on the key, and the MS re-initiates a key request to the system. For an MS in idle mode, after the system updates an encryption key, the system may check which MSs in the PC/LR request the navigation (or key) service, and page the requesting MSs. When the MSs re-enter the active mode, the MSs send a Key Request to the system; the system sends the updated encryption key to the MSs through a Reply. Alternatively, a key id field may be extended in a broadcast message carrying the geographic location information of the BS; when the key is updated, 1 is added to the key id. In this way, when the MSs find that the key id is changed, the MSs may initiate a key update request. When the MSs are in active mode, the MSs may actively obtain an updated key through the Key Request/Reply process. When the MSs are in idle mode, the MSs may actively enter the active mode, and then obtain the updated key through the Key Request/Reply process. Alternatively, the MSs initiate a location update request, and the system adds the updated key to a location update reply sent to the MSs.

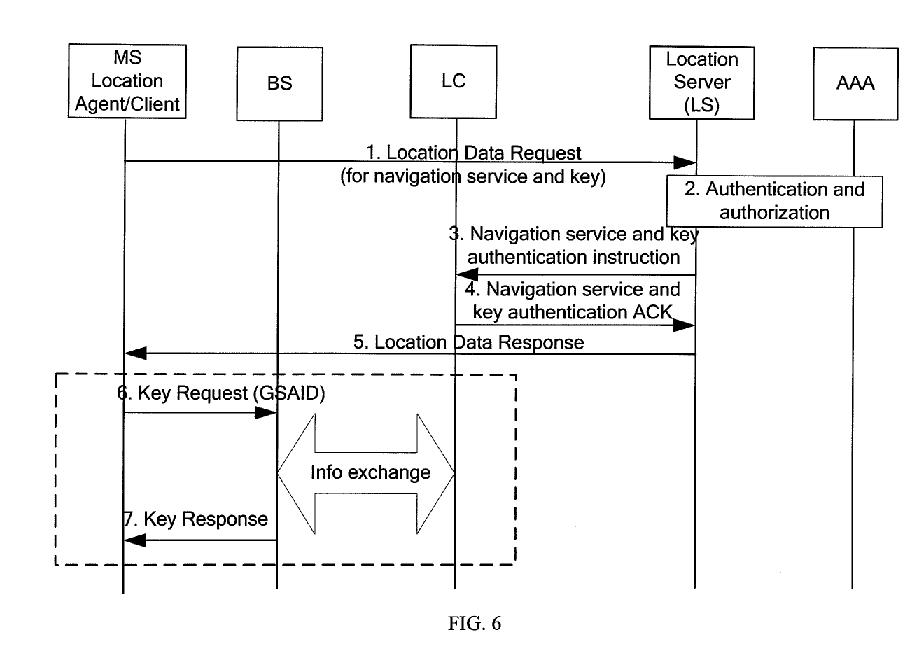

FIG. 6 illustrates a process of an embodiment of the method for broadcasting geographic location information of the BS. The process includes the following steps:

Step 1: An MS sends a Location Data Request to the LS, where the Location Data Request carries a navigation request, a key request for encrypting the geographic location information of the BS. The Location Data Request may further carry a time parameter indicating the time when the navigation or key service is used or the number of times the navigation or key service is used.

Step 2: The LS authenticates and authorizes the Location Data Request.

Step 3: After authorizing the Location Data Request, the LS sends a notification to the LC where the MS resides, notifying the LC of the information that the MS requests navigation and key services, and sends the time parameter information of the navigation and key services.

Step 4: The LC returns an ACK to the LS, and stores the preceding information, that is, the LC records the information that the MS is implementing navigation and key services and the corresponding time. The LC may also send the message to the BS, so that the BS may also obtain the information that the MS is implementing navigation and key services.

Step 5: The LS returns a Location Data Response to the MS that sends the Location Data Request, so as to approve the request of the MS. If a key for encrypting the geographic location information of the BS is configured on the LS, the LS may add the key to the Location Data Response sent to the MS.

If the key is already sent to the BS for storing, the key may be notified to the MS through step 6 and step 7.

Step 6: The MS initiates a key request that carries a specific GSAID to obtain the corresponding key information. If no key information exists in the BS or the BS does not obtain the information that the MS is implementing navigation and key services, the BS may request the information from the LC temporarily.

Step 7: The BS returns the MS a Key Response that carries the key information requested by the MS.

For an MS that is implementing the navigation service, if no other data services are being implemented, the MS may enter the idle mode from the active mode.

In this process, the anchor PC/LR of the MS stores the related information that the MS is already authorized to implement the navigation and key services. Such information may also be sent to the anchor PC/LR by the BS/LC when the MS enters the idle mode. In this case, when the MS enters the active mode from the idle mode, the ASN may not lose the information, and the MS can obtain related key information.

In addition, when the MS does not need the navigation or key service, the MS may initiate an exit request to the LS; the LS notifies the LC where the MS resides of the information that the MS requests exiting the navigation and key services; the LC deletes the navigation and key service information of the MS, and returns an ACK to the LS. The LS deletes the service related information of the MS, and returns an ACK to the MS. Further, after the time of requesting the navigation and/or key service by the MS expires, the network may actively initiate a navigation service exit process of the MS and delete related information. The process result may be notified to the MS.

To conclude, in the process of implementing the method for broadcasting the geographic location information of the BS in this embodiment of the disclosure, the BS encrypts the broadcasted geographic location information of the BS. In this way, only an MS that obtains the encryption key can decrypt the geographic location information of the BS. Thus, the security of the navigation-based LBS is improved, and the carriers can get profits from the LBS.

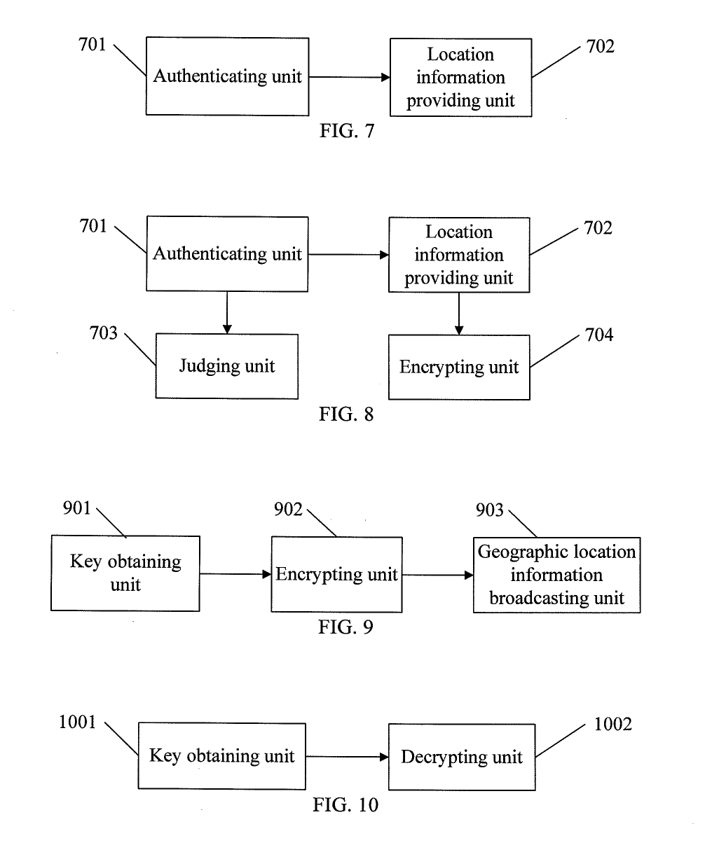

FIG. 7 shows a structure of a device in a WiMAX system providing LBSs in an embodiment of the disclosure. The device includes:

an authenticating unit 701, configured to authenticate a requesting party that requests MS location information in the WiMAX system; and

a location information providing unit 702, configured to provide the requesting party with the requested location information of the MS after the authentication succeeds.

As shown in FIG. 8, the device in the WiMAX system providing LBSs may further include:

a judging unit 703, configured to judge whether the requesting party is authorized to obtain the requested location information of the MS after the authentication succeeds.

As shown in FIG. 8, the device in the WiMAX system providing LBSs may further include:

an encrypting unit 704, configured to encrypt the location information of the MS provided to the requesting party.

In this embodiment, when the LBS is implemented in the WiMAX system, the requesting party that requests the location information of an MS in the WiMAX system is authenticated; and the location information of the MS is provided to the requesting party only after the authentication succeeds. Thus, the location information of the MS can be properly protected.

As shown in FIG. 9, a BS in a WiMAX system providing LBSs in an embodiment of the disclosure includes:

a key obtaining unit 901, configured to obtain a key;

an encrypting unit 902, configured to encrypt the geographic location information of the BS by using the obtained key; and

a geographic location information broadcasting unit 903, configured to broadcast the encrypted geographic location information of the BS.

As shown in FIG. 10, an MS in a WiMAX system providing LBSs in another embodiment of the disclosure includes:

a key obtaining unit 1001, configured to obtain a key; and

a decrypting unit 1002, configured to decrypt the broadcasted geographic location information of the BS by using the obtained key.

To conclude, a BS and an MS in a WiMAX system providing LBSs are proposed in embodiments of the disclosure. The BS encrypts the broadcasted geographic location information of the BS. In this way, only an MS that obtains the encryption key can decrypt the geographic location information of the BS. Thus, the security of the navigation-based LBS is improved, and the carriers can get profits from the LBS.

It is understandable to those skilled in the art that all or part of the steps in the methods according to the preceding embodiments may be performed by hardware instructed by a program. The program may be stored in a computer readable storage medium, such as a Read-Only Memory/Random Access Memory (ROM/RAM), a magnetic disk, and a compact disk.

It is apparent to persons skilled in the art that various modifications and variations can be made to the disclosure without departing from the scope or spirit of the invention. The invention is intended to cover the modifications and variations provided that they fall within the scope of protection defined by the appended claims or their equivalents.

1. A method for implementing location based services (LBSs), comprising:
authenticating a requesting party that requests location information of a mobile station (MS) in a World Interoperability for Microwave Access (WiMAX) system providing LBSs; and
providing the requesting party with the requested location information of the MS after the authentication succeeds.

2. The method of claim 1, further comprising: if the authentication fails, refusing to provide the requesting party with the requested location information of the MS.

3. The method of claim 1, wherein after the authentication succeeds, the method further comprises: judging whether the requesting party is authorized to obtain the requested location information of the MS; and
providing the requesting party with the requested location information of the MS if the requesting party is authorized to obtain the requested location information of the MS.

4. The method of claim 1, further comprising: encrypting the requested location information of the MS provided to the requesting party.

5. The method of claim 4, wherein the encrypting the requested location information of the MS provided to the requesting party comprises:
deriving an encryption key for encrypting the location information from a root key LBS-RK, and encrypting the location information.

6. The method of claim 1, wherein authenticating the requesting party comprises:
receiving from the requesting party a location information request carrying a first authentication extension calculated by using a shared key pre-negotiated between the requesting party and the system according to an algorithm pre-negotiated between the requesting party and the system; and
authenticating, by the system, the first authentication extension by using the shared key according to the algorithm.

7. The method of claim 1, wherein the process of authenticating the requesting party comprises:
receiving from the requesting party a location information request carrying a second authentication extension calculated by using a root key LBS-RK for LBS according to an algorithm pre-negotiated between the requesting party and the system, wherein the LBS-RK is calculated according to an extended master session key (EMSK); and
authenticating, by the system, the second authentication extension by using the LBS-RK in the system according to an algorithm pre-negotiated between the system and the requesting party.

8. The method of claim 1, wherein a third authentication extension is carried in the location information that the system provides to the requesting party and is used by the requesting party to judge whether the location information comes from the requested system.

9. A device in a World Interoperability for Microwave Access (WiMAX) system providing location based services (LBSs), comprising:
an authenticating unit, configured to authenticate a requesting party that requests location information of a mobile station (MS) in the system; and
a location information providing unit, configured to provide the requesting party with the requested location information of the MS after the authentication succeeds.

10. The device of claim 9, further comprising:
a judging unit, configured to judge whether the requesting party is authorized to obtain the requested location information of the MS after the authentication succeeds.

11. The device of claim 9, further comprising:
an encrypting unit, configured to encrypt the location information of the MS provided to the requesting party.

12. A method for broadcasting geographic location information of a base station (BS), comprising:
obtaining a key for encrypting geographic location information of a BS in a World Interoperability for Microwave Access (WiMAX) system providing location based services (LBS);
encrypting the broadcasted geographic location information of the BS based on the obtained key; and
broadcasting the encrypted geographic location information of the BS.

13. The method of claim 12, wherein the BS obtains the key generated by an operation, maintenance, and administration (OMA) device, an access service network gateway (ASN GW), a location server (LS), or an authentication, authorization, and accounting (AAA) server; and
encrypts the broadcasted geographic location information of the BS based on the obtained key.

14. The method of claim 12, further comprising:
providing a mobile station (MS) with the key by the system.

15. The method of claim 14, wherein the process of providing the MS with the key by the system comprises:
storing keys for encrypting the geographic location information of the BS in the BS, and assigning a group security association ID (GSAID) to each key;
receiving, by the BS, a key request from the MS, wherein the key request carries the GSAID corresponding to the requested key; and
searching for the key in the BS according to the GSAID carried in the key request, and sending the key to the MS.

16. The method of claim 14, wherein the process of providing the MS with the key by the system comprises:
receiving, by the system, a key request from the MS when the MS initiates a location request or when the system triggers a location request to the MS; and
sending the key for encrypting the geographic location information of the BS to the MS according to the request.

17. The method of claim 13, further comprising:
obtaining the key updated by the OMA device, the ASN GW, the LS, or the AAA server by the BS.

18. The method of claim 12, further comprising:
notifying a mobile station (MS) of an updated key by the system.

19. The method of claim 12, further comprising:
notifying, by the system, an MS of an update on the key; receiving a key request re-initiated from the MS; and
notifying the MS of the updated key according to the received request.

20. A base station (BS) in a World Interoperability for Microwave Access (WiMAX) system providing location based services (LBSs), comprising:
a key obtaining unit, configured to obtain a key;
an encrypting unit, configured to encrypt geographic location information of the BS by using the obtained key; and
a geographic location information broadcasting unit, configured to broadcast the encrypted geographic location information of the BS.
